(19) United States
(12) Patent Application Publication
(10) Pub. No.: US 2014/0348202 A1
(43) Pub. Date: Nov. 27, 2014

(54) Method for detecting presence of a droplet on a heated temperature sensor

(71) Applicant: Endress + Flowtec AG, Reinach (CH)

(72) Inventors: Fanos Christodoulou, London (GB); Axel Pfau, Aesch (CH); Martin Arnold, Reinach (CH); Michel Wagner, Birsfelden (CH)

(21) Appl. No.: 14/366,551

(22) PCT Filed: Nov. 22, 2012
(86) PCT No.: PCT/EP2012/073362

§ 371 Date: Jun. 18, 2014

(30) Foreign Application Priority Data
Dec. 22, 2011 (DE) 10 2011 089 598.1
Dec. 22, 2011 (DE) 10 2011 089 600.7

(51) Int. Cl. G01K 7/20; G01F 1/696

(52) U.S. Cl. CPC G01K 7/20; G01F 1/696
USPC 374/43

(57) ABSTRACT

A method for detecting the presence of a droplet on a heated temperature sensor, especially on a heated temperature sensor of a thermal, flow measuring device for measuring flow of a fluid. The method steps are as follows: ascertaining the greatest value of a measure for heat transfer from the heated temperature sensor to the fluid in a first time window of predetermined length; testing values of the measure for heat transfer in the first time window for the presence of values of the measure for heat transfer before and after the greatest value of the measure for heat transfer, which are less than the difference between the greatest value and a predetermined Δ₁; and applying the results of the testing for detecting the presence of a droplet.

The present invention relates to a method for detecting presence of a droplet on a heated temperature sensor, especially on a heated temperature sensor of a thermal, flow measuring device for measuring flow of a fluid.

Conventional thermal, flow measuring devices usually use two as equally as possible embodied temperature sensors, which are arranged, most often, in pin-shaped, metal sleeves, so-called stingers, and which are in thermal contact with the medium flowing through a measuring tube or through the pipeline. For industrial application, the two temperature sensors are usually installed in a measuring tube; the temperature sensors can, however, also be mounted directly in a pipeline. One of the two temperature sensors is a so-called active temperature sensor, which is heated by means of a heating unit. The heating unit is either an additional resistance heater or else the temperature sensor itself in the form of a resistance element, e.g. an RTD (Resistance Temperature Device) sensor, which is heated by conversion of electrical power, e.g. by a corresponding variation of the electrical current used for measuring. The second temperature sensor is a so-called passive temperature sensor: It measures the temperature of the medium.

To this point in time, mainly RTD elements with helically wound platinum wires have been applied in thermal, flow measuring devices. In the case of thin-film resistance thermometers (TFRTDs), conventionally, a meander-shaped platinum layer is vapor deposited on a substrate. On top of that, another glass layer is applied for protecting the platinum layer. The cross section of thin-film resistance thermometers is rectangular, in contrast with the round cross section of RTD elements. Heat transfer into the resistance element and/or from the resistance element occurs accordingly across two oppositely lying surfaces, which together make up a large part of the total surface area of a thin-film resistance thermometer.

Usually, in a thermal, flow measuring device, the heatable temperature sensor is so heated that a fixed temperature difference is established between the two temperature sensors. Alternatively, it is also known to supply a constant heating power via a control unit.

If there is no flow in the measuring tube, then an amount of heat constant with time is required for maintaining the predetermined temperature difference. If, in contrast, the medium to be measured is moving, the cooling of the heated temperature sensor is essentially dependent on the mass flow of the medium flowing past. Since the medium is colder than the heated temperature sensor, the flowing medium transports heat away from the heated temperature sensor. In order thus in the case of a flowing medium to maintain the fixed temperature difference between the two temperature sensors, an increased heating power is required for the heated temperature sensor. The increased heating power is a measure for the mass flow of the medium through the pipeline.

If, in contrast, a constant heating power is supplied, then, as a result of the flow of the medium, the temperature difference between the two temperature sensors lessens. The particular temperature difference is then a measure for the mass flow of the medium through the pipeline, respectively through the measuring tube.

There is, thus, a functional relationship between the heating energy needed for heating the temperature sensor and the mass flow through a pipeline, respectively through a measuring tube. The dependence of the heat transfer coefficient on the mass flow of the medium through the measuring tube, respectively through the pipeline, is utilized in thermal, flow measuring devices for determining the mass flow. Devices, which operate according to this principle, are manufactured and sold by the applicant under the marks ‘t trend’ and ‘t mass’.

DE 10 2008 043 887 A1 describes a method for detection of droplets, which condense in a gaseous environment on one of the temperature sensors of a thermal, flow measuring device.

An object of the invention is to detect presence of droplets on a heated temperature sensor.

The object is achieved by the subject matter of independent claim 1. Further developments and embodiments of the invention are set forth in the features of the respectively dependent claims.

Advantages of the invention include that the operator of a plant is warned that a two-phase flow is present and thereby, on the one hand, that the ascertained flow is not being correctly measured, and, on the other hand, that mechanical components of downstream machines, such as e.g. the blades of a turbine, could be damaged.

A thermal, flow measuring device, especially one working according to the anemometer principle, includes at least one heated temperature sensor, especially a resistance thermometer. Along with that, it can have an unheated temperature sensor, wherein the temperature sensors are in contact with a fluid.

According to the invention, for detecting presence of a droplet, respectively for detecting formation of a droplet, on a heated temperature sensor of a thermal, flow measuring device for measuring the flow, especially the mass flow, of a fluid, first of all, the greatest value of a measure for heat transfer from the heated temperature sensor to the fluid in a first time window of predetermined length is ascertained. Then, it is checked whether values of the measure for heat transfer in the first time window before and after the greatest value of the measure for heat transfer are present and are less than the difference between the greatest value and a Δ₁ of predetermined size. The result of the testing is applied for detecting the presence of a droplet.

According to the invention, for detecting presence of a droplet, respectively for detecting formation of a droplet, on a heated temperature sensor of a thermal, flow measuring device for measuring the flow, especially the mass flow, of a fluid, first of all, a measure for heat transfer from the heated temperature sensor to the fluid is examined for the presence of a periodicity in a predetermined interval. The result of this investigation, thus the information whether a periodicity is present in the predetermined interval, is then applied for detecting the presence of a droplet. In given cases, other information is evaluated, such as e.g. which period the periodicity present in the predetermined interval has.

Heat can be transferred in different ways, e.g. by means of convection and radiation. Here, there is a heat flow at an interface between heated temperature sensor and fluid. The heat moves, in such case, principally from the heated temperature sensor to the fluid. However, heat can also flow from the fluid to the heated temperature sensor, e.g. when heat is expelled by condensation of gaseous fluid at the interface between heated temperature sensor and fluid.

In contrast to DE 10 2008 043 887 A1, it is not so much to detect, at phase boundaries of the fluid, droplets, which condense on the heated temperature sensor, as it is to detect droplets in a wet gas flow, especially in biogas. Thus, in an embodiment of the invention, the heated temperature sensor of the thermal, flow measuring device is applied in a gaseous flow having a relative humidity of at least 80%. In a form of embodiment of the invention, droplets are detected in an otherwise gaseous flow having a relative humidity of 100% or even in a supersaturated flow.

A measure for heat transfer is, for example, the heating power for heating the heated temperature sensor when a predetermined temperature difference is set between heated temperature sensor and unheated temperature sensor of the thermal, flow measuring device. If, however, the heating power for heating the heated temperature sensor is held constant, the temperature difference between heated temperature sensor and unheated temperature sensor of the thermal, flow measuring device is a measure for the heat transfer. Naturally, there exist also mixed forms, such as the so-called power coefficient. This is calculated, for example, by applying the formula PC(t₀)=P(t₀)/(T_{Heated}(t₀)−T_{Medium}(t₀)) at a point in time to, wherein PC stands for the power coefficient, P is the heating power, T_{Heated} is the temperature of the heated temperature sensor and T_{Medium} is the temperature of the unheated temperature sensor of the thermal, flow measuring device.

In a first further development of the invention, for detecting presence of a droplet on a heated temperature sensor of a thermal, flow measuring device, the greatest value of the heating power for heating the heated temperature sensor in a first time window of predetermined length is ascertained. For example, a curve of heating power signal versus time is plotted and the global maximum x_{M} of the curve of the heating power signal in the first time window ascertained. Then, the curve is checked for the presence of a value xₗ left of the global maximum x_{M} and for the presence of a value xᵣ right of the global maximum x_{M}, which values xₗ and xᵣ lie in the predetermined first time window and for which it holds that x_{y}≦x_{M}−Δ₁, with y=r,l and with Δ₁ of a predetermined size. If the said values x_{y}≦x_{M}−Δ₁ with y=r,l exist in the first time window, then presence of a droplet is recognized.

In a further development of the invention, detection of the presence of a droplet is signaled e.g. by output of a signal, especially an alarm-signal. Alternatively, the flow signal is corrected or output as untrustworthy, respectively burdened by error or not taken into consideration for calculating the flow in a time window around the arisen presence of a droplet.

In an additional further development of the method of the invention, following the preceding method steps, the first time window is shifted by a predetermined measure to the right, thus to a later point in time. Thereafter, the method can begin anew.

The predetermined measure amounts, in such case, especially exactly, to a discrete value. A typical sampling rate for the method of the invention amounts to between 4 and 200 Hz.

In an additional further development of the invention, the predetermined length of the first time window amounts to between 1.5 and 20 seconds. In the case of a sampling rate of 100 Hz for digitizing an analog signal, here the measure of the heat transfer, there results, thus, a length of the first time window of 150 to 2000 discrete measured values.

Further developed, the predetermined Δ₁ amounts to between 0.005 and 0.06 watt, when the measure for heat transfer is the heating power for heating the heated temperature sensor.

At the same time or subsequently, according to a further development of the invention, supplementally, method steps as follows can be performed for detecting presence of a droplet on a heated temperature sensor of a thermal, flow measuring device for measuring flow of a fluid:

examining a measure for heat transfer from the heated temperature sensor to the fluid for the presence of a periodicity in a predetermined interval. The result of this investigation, thus information concerning whether a periodicity is present in the predetermined interval, is then applied for detecting the presence of a droplet. In given cases, other information is evaluated, such as e.g. the period of the periodicity present in the predetermined interval.

In an additional further development of the invention, for detecting presence of a droplet on a heated temperature sensor of a thermal, flow measuring device, the heating power for heating the heated temperature sensor is examined for the presence of a periodicity in a predetermined interval and the periodicity present in the predetermined interval applied for detecting the presence of a droplet. The presence of a periodicity in a predetermined interval means that the period, thus the time between two events, respectively the frequency of the events, is greater than a predetermined minimum value and less than a predetermined highest value, wherein the minimum and highest values form the limits of the predetermined interval.

For example, a heating power signal is plotted versus time. The signal is examined for periodicities, for example, by means of a Fourier transformation, especially a fast Fourier transformation (FFT). Then, it is examined whether the period lengths lie in an interval of predetermined size, thus whether a periodicity is present in the predetermined interval. If this is the case, then presence of a droplet is recognized.

In general, for investigating the measure for heat transfer from the heated temperature sensor to the fluid for the presence of a periodicity in a predetermined interval, a Fourier transformation of the measure for heat transfer can be applied.

The said Fourier transformation is not the only opportunity for investigating for the presence of a periodicity. Along with that, there is, for example, also the auto-correlation function. In a further development of the invention, for investigating the measure for heat transfer from the heated temperature sensor to the fluid, especially for investigating the heating power for heating the heated temperature sensor, for the presence of a periodicity, method steps are performed as follows:

ascertaining the greatest value of the measure for heat transfer in a second time window of predetermined length;

testing the values of the measure for heat transfer in the second time window for the presence of a second value of the measure for heat transfer after the first, greatest value of the measure for the heat transfer, which is less than the difference between the first, greatest value and a predetermined Δ₂;

storing the point in time of the first, greatest value of the measure for heat transfer in the case of presence of the second value of the measure for the heat transfer;

shifting the second time window by a predetermined measure to a later point in time;

repeating the above method steps;

ascertaining the separations of three stored points in time following one after the other;

testing an interval of predetermined size for encompassing the respective separations in time.

Thus, for example, first of all, a curve of the signal of the heating power for heating the heated temperature sensor is plotted versus time and the global maximum x_{M} of the curve in the second time window ascertained. Then, it is checked whether, in the second time window, a value xᵣ to the right of the maximum exists, for which: Xr≦x_{M}−Δ₁, with a Δ₁ of predetermined size. In case such a value xᵣ exists, at least the time value of the maximum is stored permanently in a memory for later application. Thereafter, the second window is shifted by a predetermined measure to the right and said method steps repeated in this section, until at least three time values of three global maxima in three second time windows are stored. A shifting to the right means that the window is shifted to a later point in time. Analogously, an earlier point in time is located to the left and a later point in time to the right of the starting point in time.

If three time values are stored, their time separations relative to one another are ascertained. If these separations correspond to a period length in an interval of predetermined size, if thus the two ascertained separations lie above a lower limit value and under an upper limit value, then the presence of a predetermined periodicity has been detected and is, in given cases, output. The storing of time values occurs, for example, by means of a time stamp, which associates a point in time with the event of the invention.

In an additional further development of the invention, the predetermined length of the second time window amounts to between 1.5 and 20 seconds. In the case of a sampling rate of 100 Hz for digitizing an analog signal, here the measure of the heat transfer, there results, thus, a length of the first time window of 150 to 2000 discrete measured values. A typical sampling rate for the method of the invention amounts to between 4 and 200 Hz.

Further developed, the predetermined Δ₁ amounts to between 0.005 and 0.06 watt, in case the measure for heat transfer is the heating power for heating the heated temperature sensor.

Another further development adds the feature that the second time window is shifted by exactly one discrete value to the right. Naturally, thus, in a plurality of first time windows following one after the other, always the same point in time can be identified, which, according to the invention, should be stored. Of course, only points in time are evaluated, which have a separation greater than zero relative to one another.

In an additional further development of the method of the invention, the heated temperature sensor is heated periodically, wherein the periodicity of the heating periods is less than the periodicity in the predetermined interval for detecting the presence of a droplet. The periodicity of the heating periods falls, thus, not in the interval of the periodicity of the measure for heat transfer for detecting, the presence of a droplet.

The predetermined interval for detecting the presence of a droplet checked for the presence of the periodicity of the measure for heat transfer amounts, further developmentally, to 15 to 3000 seconds, respectively a corresponding number of discrete values, in the case of a sampling rate typical for the invention.

Naturally, also the two droplet types can occur together, so that the combination of the two described method parts leads to an increase of the probability of detecting the presence of a droplet. The individual method steps can, in such case, follow sequentially one after the other or be executed simultaneously, especially when the lengths of the respective time windows are selected correspondingly, especially when, the first and second time windows are equally long.

Corresponding to a further development of the invention, thus, the length of the first time window equals the length of the second time window. In an additional further development of the invention, Δ₁ equals Δ₂.

At the same time or subsequently in time, according to a further development of the invention, supplemental method steps for detecting presence of a droplet on a heated temperature sensor of a thermal, flow measuring device for measuring flow of a fluid can be performed as follows:

ascertaining the greatest value of a measure for heat transfer from the heated temperature sensor to the fluid in a second time window of predetermined length;

testing whether values of the measure for heat transfer in the second time window before and after the greatest value of the measure for heat transfer are present, which are less than the difference between the greatest value and a Δ₂ of predetermined size. The result of the testing is then applied for detecting the presence of a droplet.

The invention permits numerous forms of embodiment. Some thereof will now be explained in greater detail based on the figures of the appended drawing. Equal elements are provided in the figures with equal reference characters. The figures of the drawing show as follows:

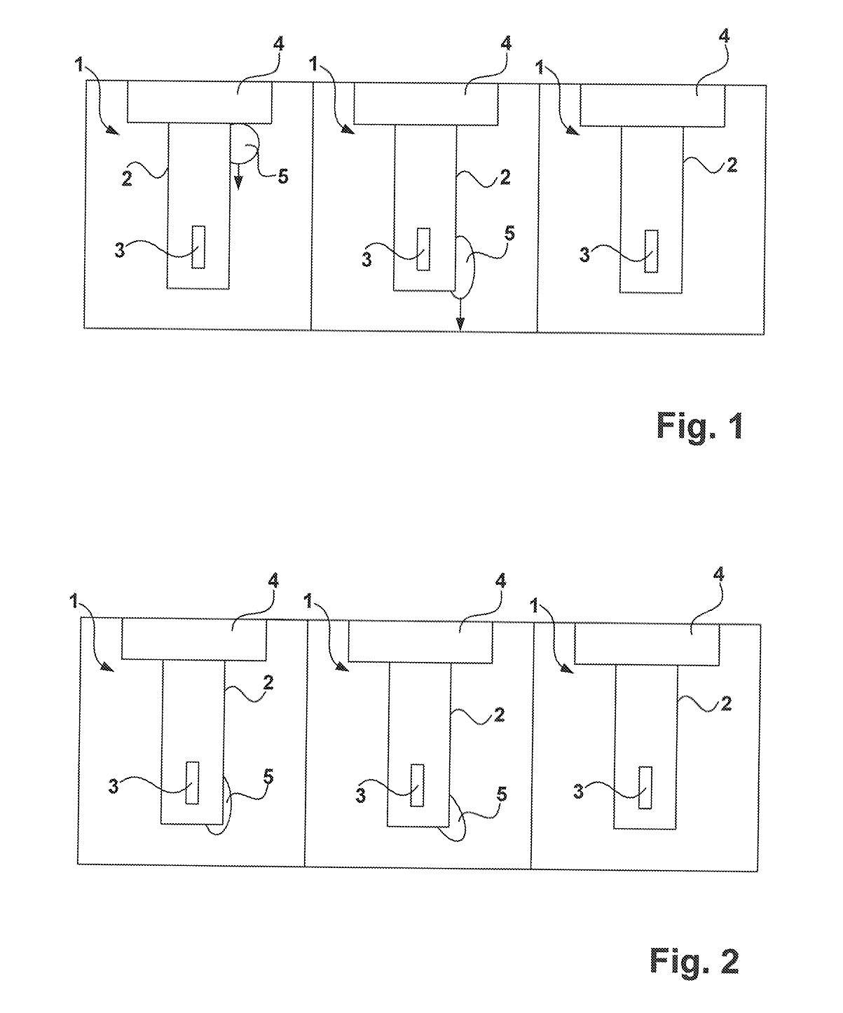

FIG. 1 a first presence of a droplet on a temperature sensor,

FIG. 2 a second presence of a droplet on a temperature sensor,

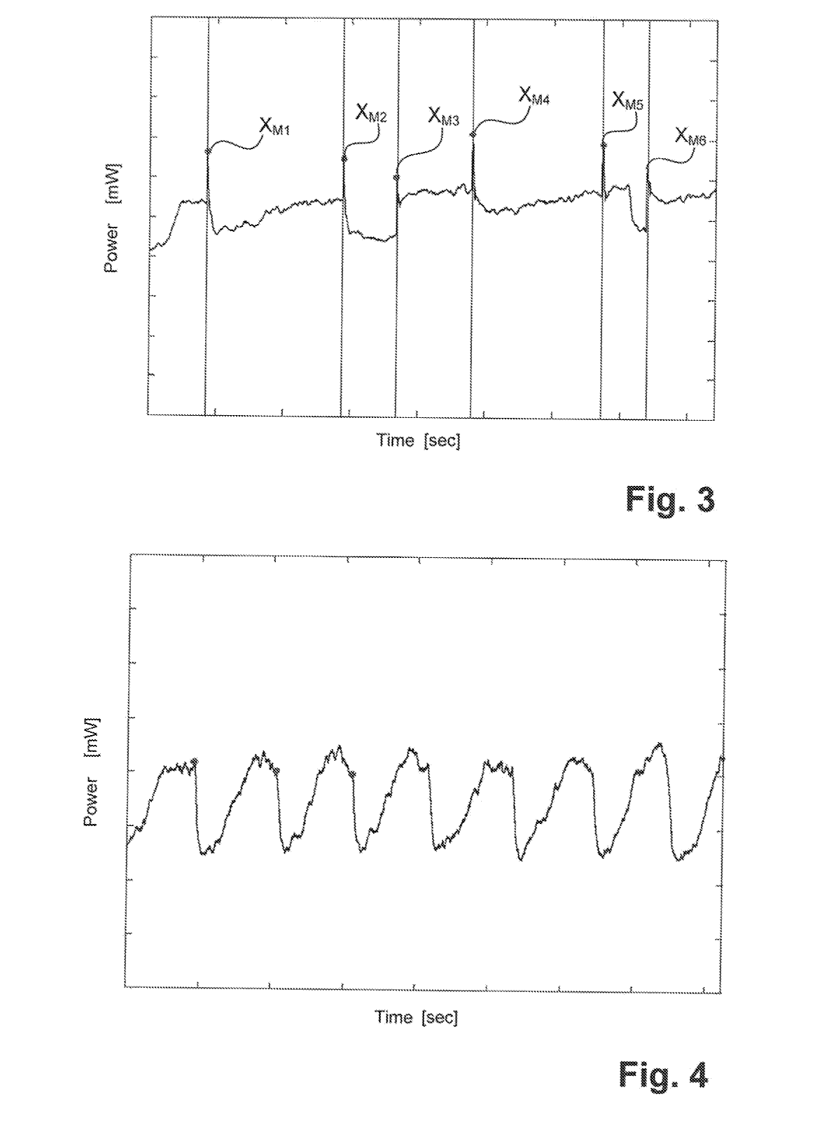

FIG. 3 a first heating power curve,

FIG. 4 a second heating power curve,

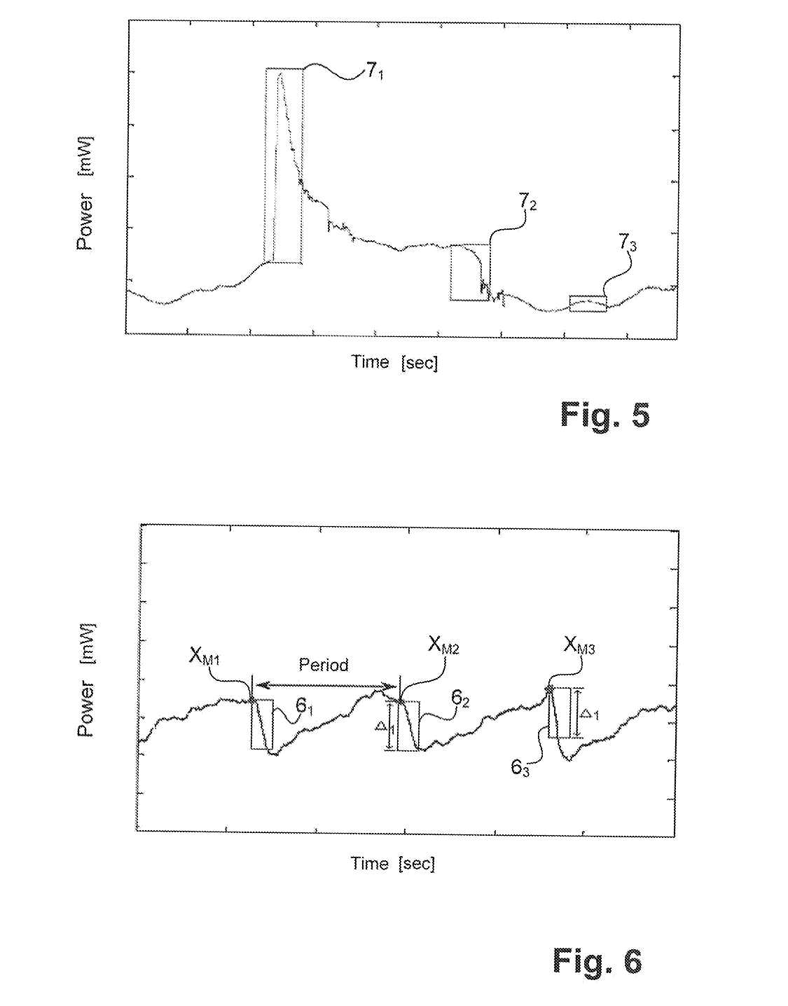

FIG. 5 a third heating power curve,

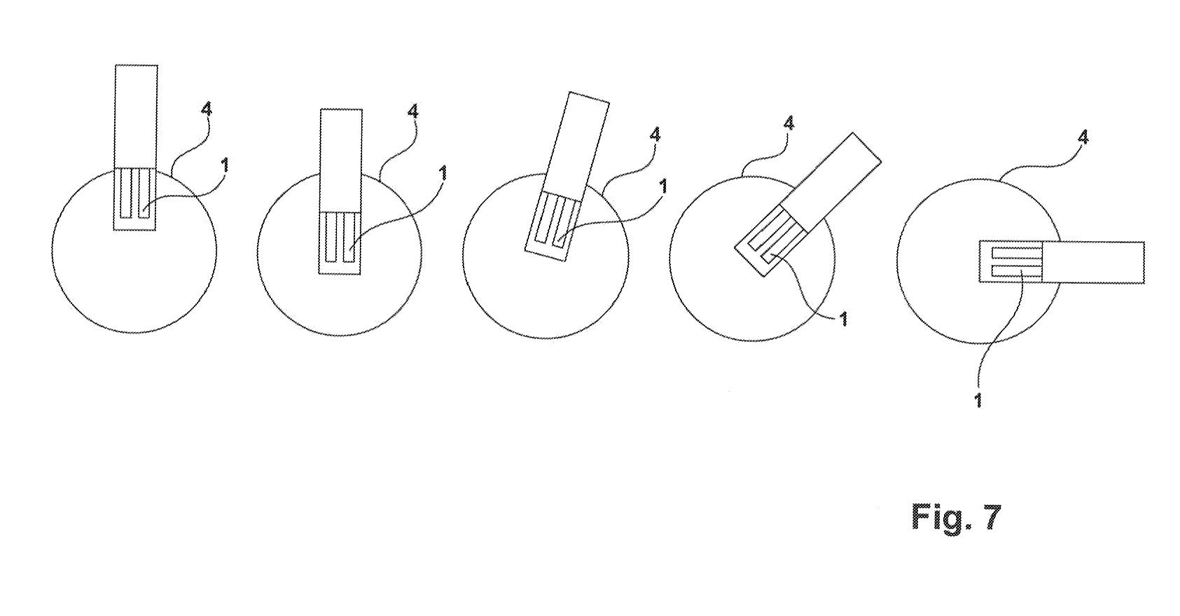

FIG. 6 a fourth heating power curve,

FIG. 7 thermal, flow measuring devices of the invention installed in different ways.

The terminology, presence of a droplet, means the presence of a droplet on a surface of the thermal, flow measuring device, such that the droplet has an interface with the fluid. In the following, the invention will be explained in greater detail based on the heating power as measure for the heat transfer. This is intended to be representative for all measures of heat transfer.

There are different types of droplets, which can be detected with a method of the invention. Here, only some selected examples will be explained in greater detail, without making any claim of completeness.

FIGS. 1 and 2 illustrated two types of droplets 5, which occur at sequential points in time relative to one another. FIGS. 3 and 4 show the respectively associated signals of a heating power for heating a heated temperature sensor 1 plotted versus time. The heated temperature sensor 1 of a thermal, flow measuring device comprises here a pin-shaped shell 2 in which a resistance thermometer 3 is arranged, which is heatably embodied. The resistance thermometer 3 is arranged in the region of a first end of the pin-shaped shell 2, while a second end of the pin-shaped shell 2 is connected with the wall of a pipeline 4.

A droplet 5 arises, for example, at the joint between shell 2 and pipeline 4. First, it is held at that position by surface tension. The left picture of FIG. 1 shows this. Through growth of the droplet, its mass increases, and, at a later point in time, which is shown in the middle picture of FIG. 1, the droplet 5 flows on the shell 2 to the region of the resistance thermometer 3 at the first end of the shell 2 and eventually drops away from the shell 2, such as indicated in the right picture. On the path past the resistance thermometer 3, a quantity of heat is absorbed by the droplet 5, which leads to a shock-like rise of the heating power, when, for example, a constant temperature difference between the heated temperature sensor and an unheated temperature sensor must be maintained. The heating power then falls shock like, when the droplet 5 leaves the region of the resistance thermometer 3. FIG. 3 shows the time curve of the heating power in the case of the occurrence of a plurality of droplets of the described type. The droplets bring about, in each case, an excursion in the curve of the heating power signal versus time, with the greatest value being X_{Mz}, where z=1, 2, 3, 4, 5, 6. These excursions are applied for detection according to the invention. Thus, the greatest value of a heating power for heating the heated temperature sensor is ascertained in a first time window of predetermined length, then the values of heating power are checked in the first time window for the presence of values right and left of the greatest value of heating power, which are less than the difference between the greatest value and a predetermined Δ₁. Then, results of this testing are applied for detecting the presence of a droplet.

Another type of presence of a droplet is sketched in FIG. 2. As in FIG. 1, time sequential states are shown in the pictures from left to right. The droplet 5 grows in the region of the first end of the pin-shaped shell 2 and achieves in the middle picture of FIG. 2 a critical mass, so that it falls from the shell 2, whereupon the droplet is no longer present in the right picture. By growing in the region of the heated resistance thermometer 3, the heating power does not increase abruptly, but, instead, continuously up to the point in time when the droplet 5 falls away. Then the heating power decreases abruptly. It was observed that this droplet growth repeats periodically. FIG. 4 plots the time curve of the heating power for heating the temperature sensor in the case of a periodic presence of a droplet.

This periodically occurring presence of a droplet is detected according to the invention by examining the heating power for heating the heated temperature sensor for the presence of a periodicity in a predetermined interval and applying discovered periodicity in the predetermined interval for detecting the presence of droplets.

The type of droplet condensing on the temperature sensor is subject to a series of influencing factors. Some thereof will be explained in greater detail based on FIG. 7.

FIG. 5 shows the time curve of a heating power signal, along with three first time windows 6₁, 6₂, and 6₃.

In the first time window 6₁, the criterion for detecting presence of a droplet is fulfilled, since within the first time window 6₁, both before as well as also after the highest value of the heating power in the time window, values exist, which are less than the difference between the highest value and a predetermined Δ₁.

In the first time windows 6₂ and 6₃, this is, in contrast, not the case, since in the first time window 6₂, indeed, such a value exists to the right of the highest value in the first time window 6₂, however, not to the left thereof. In the first time window 6₃, none of the values subceed, or fall beneath, the limit value formed by the difference between the highest value and a predetermined Δ₁.

FIG. 6 shows a further time curve of heating power. Three points X_{M1}, X_{M2} and X_{M3} form the first, greatest value of the heating power in their respective second time windows 7₁, 7₂ and 7₃, for which, within the respective second time window, in each case, a second value of the heating power exists, which lies to the right of the greatest value and is less than the difference between the greatest value and a predetermined Δ₂. The height of the shown time windows corresponds to the predetermined Δ₂. The separation between the first two time values t₁ and t₂ of the first two greatest values corresponds to the period, which lies in the predetermined interval. Since now also the separation between the second and third stored time value t₂ and t₃ lies within this interval, the presence of a periodicity is detected according to the invention.

The presence of a droplet is, among other things, at least dependent on the installation conditions and flow impingement conditions of the thermal, flow measuring device, especially on the angle with respect to the Earth's surface, on the entry depth into the measuring tube and on the flow velocity of the fluid in the pipeline. Above all, however, it depends on the chemical composition of the fluid and on the fractional content of droplets in an otherwise gaseous flow. Therefore, among other things, also the predetermined window lengths and the respectively predetermined Δ₁, respectively Δ₂, are dependent thereon. FIG. 7 shows a number of installation variants of a thermal, flow measuring device. On the left is a thermal, flow measuring device having a heated and an unheated temperature sensor and arranged at an angle of 0° in a pipeline. The sleeves of the two temperature sensors end at the wall of the pipeline. In the second picture from the left, the sleeves of the two temperature sensors end in the fluid, i.e. they extend further into the pipeline. The three additional pictures show from left to right three other installations. The temperature sensors extend, indeed, in each case, equally far into the pipeline, but their angles change from left to right from 15° to 45° to 90°.

In general, the predetermined length of the first and/or of the second time window and/or the magnitude of the predetermined Δ₁, respectively Δ₂, are selected as a function of the installed position of the heated temperature sensor of the thermal, flow measuring device and/or its structural embodiment, especially its medium-contacting surface and/or the flow velocity of the fluid. Along with that, decisive are the installed position, the heating power expended for the heating, the selected temperature difference between heated and unheated temperature sensors and the chemical composition as well as the thermodynamic state, such as pressure in the, and temperature of the, fluid.

### LIST OF REFERENCE CHARACTERS

1 temperature sensor
2 shell
3 resistance thermometer
4 pipeline
5 droplet
6 first time window
7 second time window

1-16. (canceled)

17. A method for detecting the presence of a droplet on a heated temperature sensor, especially on a heated temperature sensor of a thermal, flow measuring device for measuring flow of a fluid, comprising the steps of:
ascertaining the greatest value of a measure for heat transfer from the heated temperature sensor to the fluid in a first time window of predetermined length;
testing values of the measure for heat transfer in the first time window for the presence of values of the measure for heat transfer before and after the greatest value of the measure for the heat transfer, which are less than the difference between the greatest value and a predetermined Δ₁; and
applying results of the testing for detecting the presence of a droplet.

18. The method as claimed in claim 17, further comprising the steps of:
ascertaining the greatest value of a heating power for heating the heated temperature sensor in the first time window of predetermined length;
testing the values of the heating power in the first time window for the presence of values of the heating power before and after the greatest value of the heating power, which are less than the difference between the greatest value and a predetermined Δ₁; and
applying results of the testing for detecting the presence of a droplet.

19. The method as claimed in claim 17, wherein:
in the case of the presence of values before and after the greatest value of the measure for the heat transfer, especially the heating power, in the first time window, which are less than the difference between the greatest value and predetermined Δ, detection of the presence of a droplet is signaled.

20. The method as claimed in claim 17, wherein:
after the testing, the first time window is shifted by a predetermined measure to a later point in time.

21. The method as claimed in claim 17, wherein:
the predetermined length of the first time window amounts to between 1.5 and 20 seconds.

22. The method as claimed in claim 18, wherein:
the predetermined Δ₁ amounts to between 0.005 and 0.06 watt.

23. The method as claimed in claim 17, wherein:
the heated temperature sensor of the thermal, flow measuring device is applied in a gaseous flow having a relative humidity of at least 80%.

24. The method for detecting presence of a droplet on a heated temperature sensor, especially a heated temperature sensor of a thermal, flow measuring device for measuring flow of a fluid, as claimed in claim 17, further comprising the steps of:
examining a measure for heat transfer from the heated temperature sensor to the fluid for the presence of a periodicity in a predetermined interval and applying a present periodicity in the predetermined interval for detecting the presence of a droplet.

25. The method as claimed in claim 24, further comprising the step of:
examining a heating power for heating the heated temperature sensor for the presence of a periodicity in a predetermined interval and applying present periodicity in the predetermined interval for detecting the presence of a droplet.

26. The method as claimed in claim 24, wherein:
in the case of presence of a periodicity in the predetermined interval, detecting the presence of a droplet is signaled.

27. The method as claimed in claim 24, wherein:
for examining the heating power for heating the heated temperature sensor for the presence of a periodicity in a predetermined interval, a Fourier transformation of the heating power for heating the heated temperature sensor is performed.

28. The method as claimed in claim 24, wherein:
for examining the heating power for heating the heated temperature sensor for the presence of a periodicity, method steps are performed as follows:
ascertaining a first, greatest value of the heating power in a second time window of predetermined length;
testing values of the heating power in the second time window for the presence of a second value of the heating power after the first, greatest value of the heating power, which is less than the difference between the first, greatest value and a predetermined Δ₂;
storing the point in time of the first, greatest value of the heating power in the case of the presence of the second value of the heating power;
shifting the second time window by a predetermined measure to a later point in time;
repeating the above method steps;
ascertaining separations of three sequentially following, stored points in time; and
testing an interval of predetermined size for encompassing the respective separations in time.

29. The method as claimed in claim 28, wherein:
the predetermined length of the second time window amounts to between 1.5 and 20 seconds.

30. The method as claimed in claim 28, wherein:
the predetermined Δ₂ amounts to between 0.005 and 0.06 watt.

31. The method as claimed in claim 17, wherein:
the first time window and the second time window are equally long.

32. The method as claimed in claim 17, wherein:
the predetermined Δ₁ and the predetermined Δ₂ are equally large.
